(19) United States
(12) Patent Application Publication
(10) Pub. No.: US 2004/0239522 A1
(43) Pub. Date: Dec. 2, 2004

(54) Remotely accessed electrical metering system

(76) Inventor: Todd John Gallagher, Calgary (CA)

Correspondence Address: Todd John Gallagher, 80 Hidden Way NW, Calgary, AB, T3A 5S8, CA

(21) Appl. No.: 10/449,006

(22) Filed: Jun. 2, 2003

(51) Int. Cl. G08C 15/06; G08B 23/00

(52) U.S. Cl. 340/870.02

(57) ABSTRACT

An apparatus for receiving metering data from one or more induction electricity meters coupled to an electrical load and/or source of supply and for communicating said metering data to a remote location. The apparatus fits within the existing mechanical package of the induction electricity meter and includes an optical sensing device operably connected to detect the velocity and direction of the induction meter disk. A controller means is coupled to the optical sensing device. The modem transmits metering data to a remotely located receiver upon receipt of a command to transmit.

### FIELD OF THE INVENTION

The present invention relates to a device used to remotely access electrical energy meters. More particularly, the present invention relates to those energy meters with an induction type of measurement system that uses one or more mechanical disks and dials to accumulate energy imported or exported with respect to the connected electrical load. It includes a controller which retrofits to existing induction electrical meters to record and transmit energy data to the producer or billing agent. Said transmission apparatus comprising energy data codification and modem communication preferably via power line carrier to a Group Command location. Power line carrier data received at Group Command is converted to RF link for transmission to the utility or billing agency Central Command. Thus, the utility can record the energy consumption from one period to the next, promoting savings of energy and reduced peak demand on the electrical system.

### BACKGROUND OF THE INVENTION

Electrical demand is becoming more prevalent today as consumers'appetite for power pushes the energy suppliers ability to provide a reliable product to the capacity of their generation systems. Environmental, production costs, net metering and regulatory issues are causing many utilities to become insolvent or unable to economically meet generation and financial demands.

Encouraging clients to utilise electricity during low demand periods may serve as one possible solution to ease supply issues by shifting peak production to off-peak periods. While shifting demand to off-peak periods is an attractive option for the utility, there is no incentive for small consumers of electrical energy to partake in such a program utilising standard induction metering technology.

In order for the utility to encourage off-peak consumption, a method of accurately measuring consumption at specific times is required. Such a system can be used to provide consumers with a financial incentive to shift electricity use to off peak periods. Electricity meters are installed in most homes and businesses in North America yet the majority of these devices are read by manual means. A manual method of recording energy usage makes it difficult for the utility to measure residential electricity consumption more than once a month

Other advantages of providing a remote option to read meters are safety issues for meter readers, eliminating hard to read meters and decreased reading and billing costs to the utility.

One prior art system utilises a standard induction type energy meter with a pointer arm, calibrated to show the peak power usage during the current meter reading cycle. At the conclusion of the meter reading cycle, the data are recorded and the meter's peak power device is reset to zero. Such systems indicate to the utility if a given user has exceeded a given instantaneous consumption during a given period. While this system can be used to penalise a consumer for excessive peak power consumption, it does not provide an accurate means of encouraging the consumer to shift that consumption to off peak hours.

Metering systems that require manual meter reading and resetting of the meter does not assist the utility in controlling meter reading costs, nor provide a financial incentive for the consumer to shift peak consumption to periods of lower use.

Automatic means of accessing remote metering devices have been disclosed and the prior art includes the replacement of the described induction meter with an electronic meter. Such electronic meters are capable of recording very accurate timing and consumption data. As with many electronic devices, facilities may be included to provide remote metering access through power line carrier or RF link (U.S. Pat. No. 6,300,881).

Electronic metering equipment, with or without remote access capabilities, requires costly replacement. While such an upgrade is feasible for large industrial users, such a system will not become widespread enough to ensure the majority of meters are remotely accessible.

Remote accessibility of electrical meters are described in the prior art, without describing an apparatus sufficient for someone skilled in the art to comprehend. Such systems provide no descriptive element of the means of accessing the metering function. (U.S. Pat. No. 5,933,092).

Prior art systems do not describe how such systems operate when connected to distributed generation systems. It is becoming increasingly common for utilities to accept electrical energy from numerous distributed generators, using co-generation facilities or renewable energy. Such distributed generators may have specific utility supply contracts or net metering requirements, wherein energy may be imported or exported with respect to the consumer.

### SUMMARY OF THE INVENTION

Accordingly, it is an object of the present invention to provide a metering and remote accessibility system incorporating a “Meter Controller” installed in existing induction electrical energy meters. The Meter Controller means comprises an input to receive induction disk velocity and position data from an optical sensing means. Said Meter Controller means includes a method for determining energy consumption and production.

It is a further object of the present invention to include in the Meter Controller, a register to store the optical sensing data, a unique meter identification code, (possibly using the existing meter serial number) and suitable diagnostic means to ensure reliability of the accumulated data.

It is a further object of the present invention to include a communication means between the “Meter Controller” and a remotely located “Group Controller”. Said Group Controller includes a communications means, register storage means and method to communicate with at least one Meter Controller for retrieving energy consumption, production and timing data.

One preferred embodiment of the present invention contemplates the use of Power Line Carrier (PLC) communications between the Meter Controller and Group Controller means.

It is a further object of the present invention to include a communication means between the “Group Controller” and a “Central Controller”. Said Central Controller includes a communications means, register storage means and method to communicate with at least one Group Controller for retrieving energy consumption, production and timing data. Said Central Controller communicates or polls Meter Controllers via said Group Controller and comprises a method of calculating energy consumption or generation, defective meters, power system faults and diagnostic functions.

Other advantages, objects and features of the present invention will be readily apparent to those skilled in the art from a review of the detailed description of the preferred embodiment in conjunction with the accompanying drawings and claims.

### BRIEF DESCRIPTION OF THE DRAWINGS

The embodiments of the invention will now be described with reference to the accompanying drawings, in which:

FIG. 1a is a view of a typical induction style energy meter commonly used throughout North America;

FIG. 1b shows a side view of a typical induction style energy meter with one preferred embodiment of the present invention meter controller;

FIG. 2 shows a series of induction style energy meters equipped with one preferred embodiment of the present invention Meter Controller, interconnected in a series, known as a “node”;

FIG. 3 shows a node, as defined in FIG. 2, interconnected to a Group Controller with RF link transmitting data to a Central Controller located in a utility or billing agency office;

FIG. 4 shows a group of nodes communicating with a relay station and utility meter reader using a handheld version of a Central Controller.

With respect to the above drawings, similar references are used in different Figures to denote similar components.

### DETAILED DESCRIPTION OF THE INVENTION

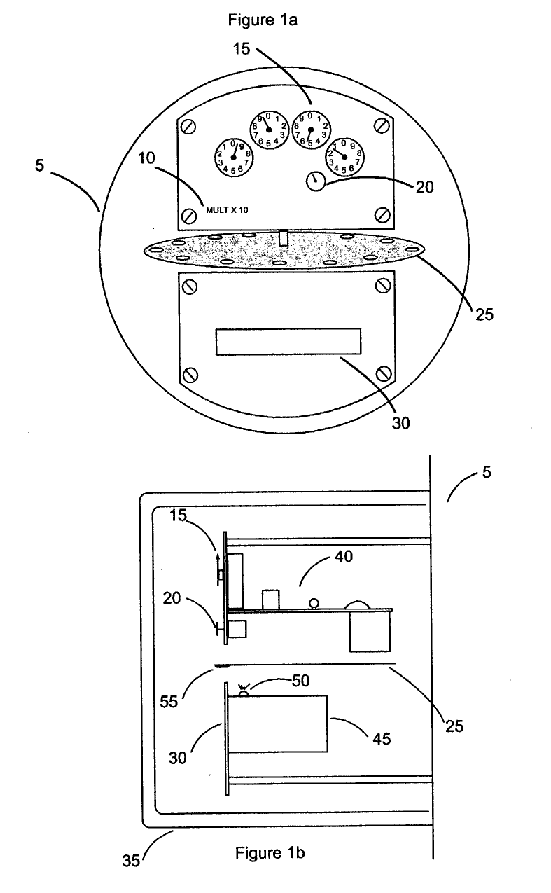

Referring to FIG. 1a , there is shown a front view of a typical induction style electric energy meter 5 commonly used in North America. Such meters are comprised of a spinning induction disk 25 that rotates at a velocity directly proportional to the energy imported or exported through the meter. For further clarity, electrical energy is normally imported from an electrical generation facility to be consumed at a load connected to the output side of said meter. Where distributed generation facilities exist, such as co-generation or renewable energy, net metering sites, electrical energy may be exported from the “consumer” back to the utility. The induction disk 25 will rotate in one direction for energy consumed and the opposite direction for energy exported, resulting in a net metering scheme.

Gears and other means to one or more energy dials 15 connect the rotation of induction disk 25. Also coupled to the energy dial mechanism is a test dial 20 that is used to insure accuracy of the meter.

A meter multiplier factor 10 is provided to relate the readings on the energy dials 15 to the units of energy to which the meter was calibrated. For example, viewing the meter energy dials 15 and multiplying this reading by the multiplier factor 10 will derive the energy in kilo Watts-hours.

A meter tag and serial number 30 are provided to indicate the manufacturing and accuracy certification of the meter unit 5.

Referring now to FIG. 1B there is shown a side view of meter 5 with its protective glass cover 35 installed and one preferred embodiment of the present invention, Meter Controller 45. In this side view of meter 5 meter electrical circuits 40, which in turn operate energy dials 15 and test dial 20, drive the induction disk 25. The underside of the induction disk 25 is often provided with a distinctive marking 55 to allow viewing of one complete rotation of the disk.

The Meter Controller 45 is operably connected to an optical sensing unit 50, which is able to detect the rotation and direction of induction disk 25, using technology similar to an optical computer mouse.

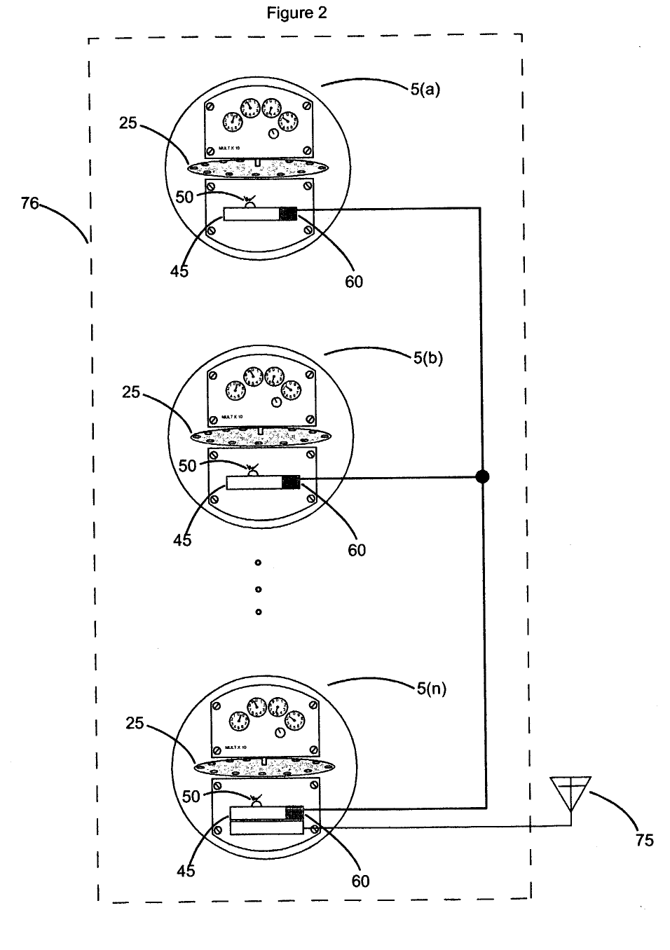

Referring now to FIG. 2, there is shown a group of induction meters 5(a), 5(b) and 5(n) equipped with one preferred embodiment of the present invention, Meter Controller 60. This grouping of meters and controller is called a “node”.

Meter 5(n) is the last meter in the node. The number of meters in a given node size is dependant on several factors, primarily how many meters are serviced by one feeder transformer. One preferred embodiment of the Meter Controller 45 is the use of Power Line Carrier (PLC) communications. This communication structure uses a modem means 60 that is operably coupled to the Meter Controller means 45 and the mains power supply line 65. PLC communications is typically limited to supplying one node, from one transformer.

Meter 5(n) in one preferred embodiment of the Meter Controller 45, a radio link (or second modem device) 70 is operably coupled to an antenna 75. This combination of Meter Controller 45, 60 and radio link 70 and 75 comprise the “Group Controller”. The Group Controller is responsible for synchronising communications between other meters in a node and transmitting and receiving data on antenna 75.

A reader skilled in the art will recognise that such an assemblage of radio link 70 and antenna 75 comprise a wireless “hub” which may utilise Cellular Digital Packet Data, proprietary 900 MHz., 2.4 GHz. or leased radio linkage interface.

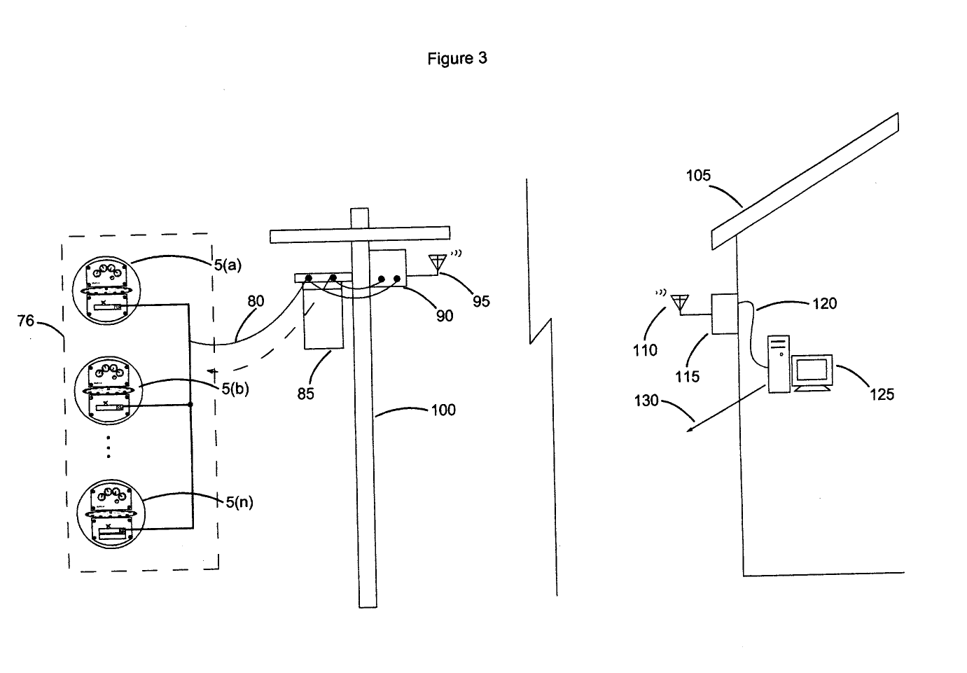

Referring now to FIG. 3, there is shown an alternate version of a node 76, wherein no radio link 70 and 75 are provided at meter 5(n). In this alternate preferred embodiment of the present invention, PLC communication is carried over power line 80 to the “low side” of distribution transformer 85. Transformer 85 is shown mounted on a “hydro pole” 100 for clarity, but it is understood that such a transformer may be mounted elsewhere.

PLC communications from node 76, through power line 80 to a radio link device 90 is operably coupled to an antenna 95. This combination of Meter 5(n) Controller 45, 60 and radio link 90 and 95 comprise an alternate “Group Controller”. The Group Controller is responsible for synchronising communications between other meters in a node and transmitting and receiving data on antenna 95.

Group Controller may communicate with a Central Controller 115, normally located at a utility office, billing agency or other desired location 105. Radio antenna 110 is operably coupled to Central Controller 115. An interface 120 connects Central Controller 115 to a computer 125. This arrangement of Central Controller 115 connected to computer 125 may complete the system, allowing computer 125 to perform billing and other functions. Computer 125 may also be connected to a LAN, WAN or Internet connection 130 for further transmission of data to additional sites, where common communication connections are available.

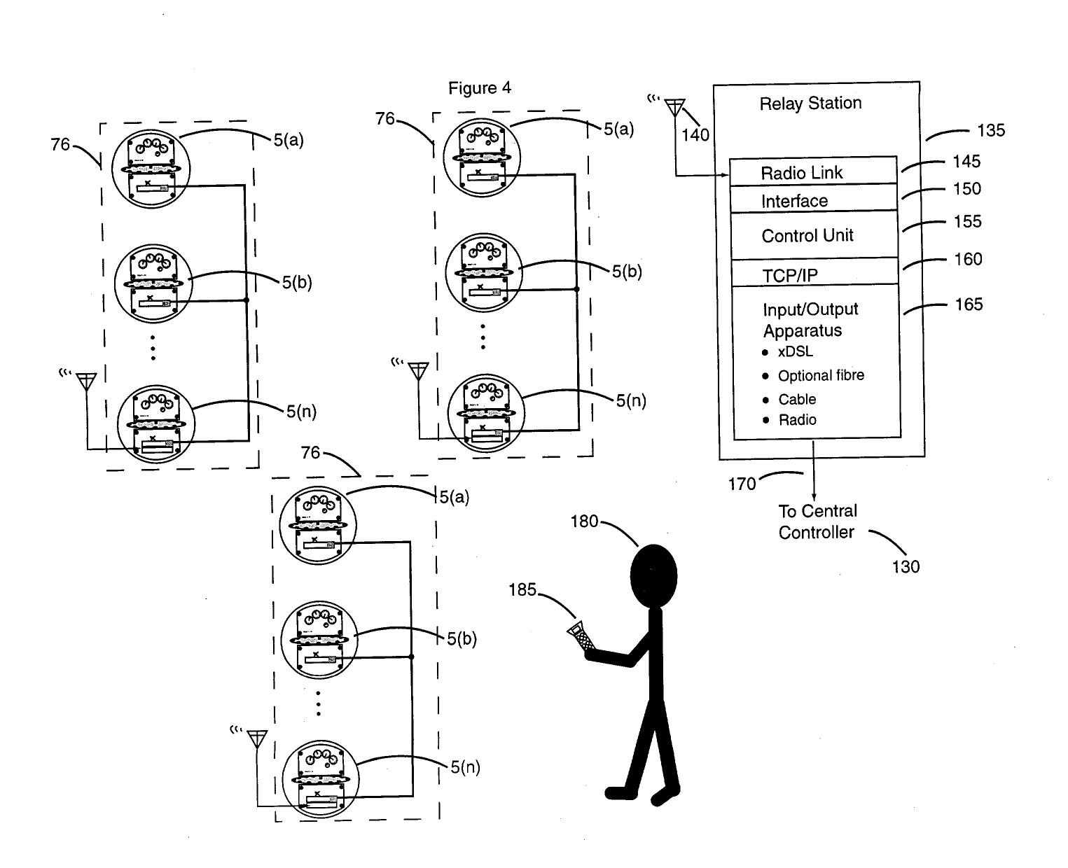

Referring now to FIG. 4 there is shown another preferred embodiment of the present invention wherein a grouping of nodes 76(a), 76(b) and 76(n) communicate to a relay station 135. Such a relay station may be used in a utility sub-station or any area where it is possible to communicate with several nodes and transfer bulk data to a utility owned LAN, WAN, xDSL, Cable or radio link 165 is available.

Data communications with nodes 76(a), 76(b) and 76(n) are available to antenna 140 which is operably connected to radio link 145. Radio link 145 is operably connected through an interface 150 to a control unit 155. Data received from said nodes or Central Controller 130 are routed to control unit 155 for processing and synchronising. Data to be transmitted to Central Controller 130 is first routed through TCP/IP protocol processor 160 and passed to the appropriate input and output apparatus 165 for transmission 175.

Another preferred method of communicating with nodes 76(a), 76(b) and 76(n) is with a portable version of a Central Controller 185. This portable device may be used where remote communications are not practical. Having utility personnel 180 using a portable Central Controller 185 will improve meter reading time and still allow time of day billing.

A reader skilled in the art will recognise while communications links using radio or PLC means have been described in there preferred embodiment of the present invention, that substitution of other means does not depart from the herein invention. Due to extremes in distance, topography or other variable, one communications means may be chosen for one site, wherein another similar site, alternate communications means are selected.

Numerous modifications, variations and adaptations may be made to the particular embodiments of the invention described above without departing from the scope of the invention, which is defined in the claims.

What is claimed is:

1. An apparatus for receiving metering data from one induction type electricity meter coupled to an electrical load and/or source of supply and for communicating said metering data to a remote location. Said apparatus to fit within the existing mechanical package of said induction electricity meter, the apparatus comprising:
an optical sensing device operably connected to detect the velocity and direction of the induction meter disk;
a controller means coupled to said optical sensing device;
a modem means wherein metering data is transmitted to a remotely located receiver upon receipt of a command to transmit said data.

2. An apparatus in accordance with claim 1 wherein the optical sensing device utilises an infra- red light emitting diode and optically tuned receiver.

3. An apparatus in accordance with claim 1 wherein the controller means comprises a microcomputer device

4. An apparatus in accordance with claim 1 wherein the controller means comprises a microprocessor device.

5. An apparatus in accordance with claim 1 wherein the modem means comprises a power line carrier device.

6. An apparatus in accordance with claim 1 wherein the modem means comprises a radio interface means.

7. An apparatus for receiving metering data from one or more induction electricity meters coupled to an electrical load and/or source of supply and communicating said metering data to a remote location. Said apparatus to fit within the existing mechanical package of said induction electricity meter, the apparatus comprising:
an optical sensing device operably connected to detect the velocity and direction of the first induction meter disk;
a controller means coupled to said optical sensing device;
a first modem means wherein metering data is received from a second induction meter
a second modem means wherein metering data is transmitted to a remotely located receiver upon receipt of a command to transmit said data.

8. An apparatus in accordance with claim 7 wherein the first modem means is a power line carrier device and the second modem means is a power line carrier device.

9. An apparatus in accordance with claim 7 wherein the first modem means is a power line carrier device and the second modem means is a radio communication link.

10. A method of communicating electrical energy metering data from one or more remotely located induction electrical meters 76 arranged within a coverage 135 or connection 80 area, wherein said metering data is communicated to a central controller 130 or relay station 135, the method comprising the steps of:
(a) detecting the rotational velocity and direction of the induction disk of an induction electrical meter;
(b) co-relating said rotational data to energy consumption or production;
(c) waiting for a request to transmit command from a node controller 5(n);
(d) transmitting said metering data to node controller 5(n); and
(e) node controller 5(n) re-transmitting said metering data and meter address to relay station 135 or central controller 130.
